(19) United States
(12) Patent Application Publication
(10) Pub. No.: US 2025/0289964 A1
(43) Pub. Date: Sep. 18, 2025

(54) ELECTRODEPOSITION COATING MATERIAL COMPOSITIONS COMPRISING ALKOXYLATED POLYETHYLENEIMINES

(71) Applicant: BASF COATINGS GMBH, Muenster (DE)

(72) Inventors: Sebastian FLAMME, Muenster (DE); Joerg RESSEL, Muenster (DE); Susanne WACKER, Muenster (DE); Janine JUETTEMEYER, Muenster (DE); Melina SCHULZE SPUENTRUP, Muenster (DE)

(21) Appl. No.: 18/862,591

(22) PCT Filed: May 11, 2023
(86) PCT No.: PCT/EP2023/062553

§ 371 Date: Nov. 4, 2024

(30) Foreign Application Priority Data
Jun. 9, 2022 (EP) 22178027.3

(51) Int. Cl. C09D 5/44; C25D 13/22

(52) U.S. Cl. CPC C09D 5/4473; C09D 5/4465; C25D 13/22

(57) ABSTRACT

Disclosed herein is an aqueous cathodically depositable electrodeposition coating material composition including at least one binder dispersion (I) including at least one cathodically depositable polymer (a) and at least one pigment paste (II) including at least one pigment and/or filler, where manufacture of the electrodeposition coating material composition includes mixing the binder dispersion (I) and the pigment paste (II), and where the composition also includes at least one alkoxylated polyethyleneimine (b) and where at least one alkoxylated polyethyleneimine (b) is part of the at least one binder dispersion (I) and/or part of the at least one pigment paste (II).

The present invention relates to an aqueous cathodically depositable electrodeposition coating material composition comprising at least one binder dispersion (I) comprising at least one cathodically depositable polymer (a) and at least one pigment paste (II) comprising at least one pigment and/or filler, whereby the dispersion (I) and/or the paste (II) comprises at least one alkoxylated polyethyleneimine (b). The present invention also relates to a kit of parts for manufacturing an aqueous cathodically depositable coating material composition and also a method of manufacturing such a composition. Also, the present invention relates to a method for at least partially coating an electrically conductive substrate by cathodic electrodeposition coating comprising at least steps (1) to (5) including the step (1) of immersing of the substrate at least partially into an electrodeposition coating bath, which comprises the inventive electrodeposition coating material composition. Moreover, the present invention relates to an electrically conductive substrate, which is at least partially coated with a baked inventive electrodeposition coating material composition and/or which is obtainable by the inventive method.

### BACKGROUND OF THE INVENTION

In the automobile sector, the metallic components used for manufacture must customarily be protected against corrosion. The requirements in terms of the corrosion control to be achieved are very exacting, not least because the manufacturers often offer a guarantee against rust perforation over many years. Such corrosion control is customarily achieved through the coating of the components, or of the substrates used to manufacture them, with at least one coating suitable for that purpose.

In order to be able to ensure the necessary corrosion control, it is common practice to apply an electrodeposition coating film to the metallic substrate, this substrate having possibly been pretreated by phosphatizing and/or by other kinds of pretreatments. Electrodeposition coating (electrocoat) materials are coating materials which comprise polymers as binders including optionally crosslinkers, pigments and/or fillers, and, frequently, additives. In general, there are anodically and cathodically depositable electrocoat materials. Anodic electrodeposition coating compositions comprising inter alia metal effect pigments are, e.g., disclosed in WO 2006/117189 A1. However, cathodically depositable materials have the greatest importance in industrial coating and particularly in automotive finishing. In cathodic electrodeposition coating, the substrates to be coated are immersed into an electrocoating bath and connected as the cathode. The bath has an anode as the counter electrode. The particles of the electrocoating material are stabilized with a positive charge and deposit on the cathode to form a coating film. Following deposition, the coated substrate is removed from the electrocoating bath, rinsed with water and the coating film is baked, i.e., thermally cured.

Cathodically depositable electrocoat materials are known in the prior art, for example in EP 1 041 125 A1, DE 197 03 869 A1 and in WO 91/09917 A2.

As already described, the major purpose of cathodically depositable electrocoat materials is corrosion protection of metallic substrates. In the automotive sectors, these substrates are in particular automotive bodies and also metallic component parts like transverse control arms, spring-loaded control arms or dampers. These substrates inherently comprise multiple edges due to their geometry and the processes, e.g. stamping, conducted prior to the coating steps. These edges remain a major challenge for appropriate corrosion protection by electrodeposition coating processes. While the protection of surfaces and planes may be called quite well established, the state of the art does lack optimal technical solutions at edges. Reason is, quite self-explanatory, that even under consideration of the particularities of electrodeposition and its advantages, it is challenging to ensure sufficient film build on the edges, e.g. by modification of the viscosity during the softening of the film during curing, while ensuring a sufficient material flow at the same time to achieve the desired leveling of the film on surfaces and planes. This effect is even more significant and relevant as, due to economical reasons, these days in industrial coating processes post processing steps like, for example, sanding and polishing processes of substrates edges are often omitted, meaning that sharp edges are not rounded off, but remain unchanged and thus even more difficult to be coated. Result is reduced coating thickness and thus lower corrosion protection on these edges. One measure to counter this problem is working with increased viscosity of the deposited electrodeposition material and also accelerated viscosity increase during curing. However, this, in turn, often leads to a simultaneous increase in surface roughness of the coating as the material is not able to level out after application and during cure. Increased surface roughness, however, is an effect to be avoided in the automotive coating industry as its compensation either requires severe efforts during formation of following coating layers or at all is not possible, thus leading to non-acceptable aesthetic properties of the resulting automotive multilayer coating. In fact, avoidance of high surface roughness is, simultaneously with achieving good corrosion protection, one major challenge in the context of electrodeposition coatings in the automotive industry.

Thus, there is a need to be able to provide an electrodeposition coating material, which allows for an increased corrosion protection of edges of metallic substrates without negatively impacting the surface roughness of the electrocoated substrate.

US 2010/0143632 A1 describes a composition comprising a mixture of polyethyleneimine and poly(meth)acrylic acid for gaining corrosion protection of metallic substrate. Edge corrosion protection is not described. Also, nothing about electrocoating compositions, not to speak of cathodically depositable electrocoat compositions, is disclosed. This is in line with the finding (as presented below in the example section) that such polyethyleneimines do not perform in cathodically depositable electrodeposition coating material compositions, i.e. such cathodically depositable electrodeposition coating material compositions are not depositable.

### Problem

It has been therefore an object underlying the present invention to provide an electrodeposition coating material, which allows for a smooth and homogeneous film build during its application onto metallic substrates, whereby the resulting coating shows excellent corrosion resistance in the region of edges.

### Solution

This object has been solved by the subject-matter of the claims of the present application as well as by the preferred embodiments thereof disclosed in this specification, i.e. by the subject matter described herein.

A first subject-matter of the present invention is an aqueous cathodically depositable electrodeposition coating material composition comprising
(I) at least one binder dispersion comprising at least one cathodically depositable polymer (a) and
(II) at least one pigment paste comprising at least one pigment and/or filler, wherein manufacture of the electrodeposition coating material composition comprises mixing the binder dispersion (I) and the pigment paste (II), and
wherein the composition also comprises at least one alkoxylated polyethyleneimine (b) and
wherein at least one alkoxylated polyethyleneimine (b) is part of the at least one binder dispersion (I) and/or part of the at least one pigment paste (II).

A further subject-matter of the present invention is a kit of parts for manufacturing an aqueous cathodically depositable electrodeposition coating material composition, comprising
(I) at least one binder dispersion comprising at least one cathodically depositable polymer (a) and
(II) at least one pigment paste comprising at least one pigment and/or filler,
wherein at least one alkoxylated polyethyleneimine (b) is part of the at least one binder dispersion (I) and/or part of the at least one pigment paste (II).

Also, a subject-matter of the present invention is a method of manufacturing a cathodically depositable electrodeposition coating material composition comprising
provision of (I) at least one binder dispersion comprising at least one cathodically depositable polymer (a)
provision of at least one pigment paste (II) comprising at least one pigment and/or filler,
wherein the binder dispersion (I) and/or the pigment paste (II) comprises at least one alkoxylated polyethyleneimine (b),
mixing the binder dispersion (I), the pigment paste (II) and any further potential components of the composition.

A further subject-matter of the present invention is a method for at least partially coating an electrically conductive substrate by cathodic electrodeposition coating comprising at least steps (1) to (5), namely
(1) immersing of the electrically conductive substrate at least partially into an electrodeposition coating bath, which comprises the inventive electrodeposition coating material composition,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

A further subject-matter of the present invention is an electrically conductive substrate, which is at least partially coated with a baked inventive electrodeposition coating material composition and/or which is obtainable by the inventive method.

It has been surprisingly found that the inventive electrodeposition coating material composition allows for an excellent edge corrosion protection of electrically conductive (i.e. metallic) substrates. Moreover, it has been surprisingly found that—besides the improved edge corrosion protection—the surface film homogeneity is still of high quality, i.e. surface roughness is avoided. In sum, accordingly, the present invention brings together two crucial properties of electrodeposition coatings, i.e. high edge corrosion protection and excellent film homogeneity.

### DETAILED DESCRIPTION OF THE INVENTION

The term “comprising” in the sense of the present invention, in connection for example with the electrodeposition coating material composition of the invention, includes, but does not only has the meaning of “consisting of”. Accordingly, for example with regard to the electrodeposition coating material composition of the invention, it is possible—in addition to components (a), (b) and water—for one or more of the further components identified hereinafter and included optionally in the electrodeposition coating material composition of the invention to be included therein.

All components may in each case be present in their preferred embodiments as identified below. “Consisting of” may also be called “Only comprising” or “Exclusively comprising”, i.e. “comprising” may be called a generic term which includes the specific term “consisting of”.

### Inventive Electrodeposition Coating Material Composition

The cathodically depositable aqueous electrodeposition coating material composition of the invention (also named hereinafter inventive electrodeposition coating material composition or inventive composition) comprises at least one binder dispersion (I) comprising at least one cathodically depositable polymer (a) (also named component (a)) and at least one pigment paste (II) comprising at least one pigment and/or filler.

At least one, preferably exactly one, of component (I) and (II) comprise at least one alkoxylated polyethyleneimine (b) (also named component (b)). Preferably, the inventive composition comprises exactly one alkoxylated polyethyleneimine (b). The inventive composition also comprises water. The terms “electrodeposition coating material composition” and “electrodeposition coating composition” used herein are interchangeable.

The cathodically depositable aqueous electrodeposition coating material composition of the invention is suitable for at least partially coating an electrically conductive substrate with an electrodeposition coating composition, meaning that it is suitable for an at least partial application to the substrate surface of an electrically conductive substrate and whose application leads to an electrodeposition coating film onto the surface of the substrate.

The cathodically depositable electrodeposition coating material composition of the invention is aqueous. The term “aqueous” in connection with the electrodeposition coating material composition of the invention is understood preferably for the purposes of the present invention to mean that water, as solvent and/or as diluent, is present as the main constituent of all solvents and/or diluents present in the electrodeposition coating material composition, preferably in an amount of at least 35 wt.-%, based on the total weight of the electrodeposition coating composition of the invention. Organic solvents may be present additionally in smaller proportions, preferably in an amount of <20 wt.-%.

The electrodeposition coating composition of the invention preferably includes a water fraction of at least 40 wt.-%, more preferably of at least 50 wt.-%, still more preferably of at least 60 wt.-%, yet more preferably of at least 65 wt.-%, in particular of at least 70 wt.-%, most preferably of at least 75 wt.-%, based in each case on the total weight of the electrodeposition coating composition.

The electrodeposition coating composition of the invention preferably includes a fraction of organic solvents that is <10 wt.-%, more preferably in a range of from 0 to <10 wt.-%, very preferably in a range of from 0 to <7.5 wt.-% or of from 0 to <5 wt.-% or of from 0 to 2 wt.-%, based in each case on the total weight of the electrodeposition coating composition. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethylene glycol, propylene glycol and butyl glycol ethers and also their acetates, butyl diglycol, diethylene glycol dimethyl ether, cyclohexanone, methyl ethyl ketone, methyl isobutyl ketone, acetone, isophorone, or mixtures thereof. Prominent examples of such organic solvents are, for example, ethylene glycol ethers like butyl glycol or propylene glycol ethers like butoxy propanol or phenoxy propanol.

The solids content of the electrodeposition coating material composition of the invention is preferably in a range of from 5 to 35 wt.-%, more preferably of from 7.5 to 30 wt.-%, very preferably of from 10 to 27.5 wt.-%, more particularly of from 12.5 to 25 wt.-%, most preferably of from 15 to 22.5 wt.-% or of from 15 to 20 wt.-%, based in each case on the total weight of the electrodeposition coating composition. The solids content, in other words the nonvolatile fraction, is determined in accordance with the method described hereinafter.

The electrodeposition coating material composition of the invention preferably has a pH in the range of from 2.0 to 10.0, more preferably in the range of from 2.5 to 9.5 or in the range of from 2.5 to 9.0, very preferably in the range of from 3.0 to 8.5 or in the range of from 3.0 to 8.0, more particularly in the range of from 2.5 to 7.5 or in the range of from 3.5 to 7.0, especially preferably in the range of from 4.0 to 6.5, most preferably in the range of from 3.5 to 6.5 or of from 5.0 to 6.0.

The electrodeposition coating material of the composition includes component (a) preferably in an amount in a range of from 15 to 85 wt.-%, more preferably of from 20 to 80 wt.-%, very preferably of from 25 to 77.5 wt.-%, more particularly of from 30 to 75 wt.-% or of from 35 to 75 wt.-%, most preferably of from 40 to 70 wt.-% or of from 45 to 70 wt.-% or of from 50 to 70 wt.-%, based in each case on the total solids content of the electrodeposition coating composition. Alternatively, the electrodeposition coating material composition of the invention includes component (a) preferably in an amount in a range of from 1 to 80 wt.-%, more preferably of from 2.5 to 75 wt.-%, very preferably of from 5 to 70 wt.-%, more particularly of from 7.5 to 65 wt.-%, most preferably of from 8 to 60 wt.-% or of from 10 to 50 wt.-%, based in each case on the total weight of the electrodeposition coating material composition respectively the coating bath.

The electrodeposition coating material of the composition includes component (b) preferably in an amount in a range of from 0.01 to 10 wt.-%, more preferably of from 0.05 to 5.0 wt.-%, very preferably of from 0.1 to 2.5 wt.-%, more particularly of from 0.2 to 1.4 wt.-%, most preferably of from 0.4 to 1.2 wt.-% or of from 0.6 to 1 wt.-%, based in each case on the total weight of the electrodeposition material coating composition.

In case of lower amounts of component (b) in some cases a decreased edge corrosion protection may result. On the other hand, in case of higher amounts of component (b), in some cases an increased surface roughness and thus lower homogeneity might result.

In case the electrodeposition coating material composition of the invention additionally includes at least one crosslinking agent component (c), which is preferred, said component (c) is preferably present in an amount in the range of from 5 to 45 wt.-%, more preferably of from 6 to 42.5 wt.-%, very preferably of from 7 to 40 wt.-%, more particularly of from 8 to 37.5 wt.-% or of from 9 to 35 wt.-%, most preferably of from 10 to 35 wt.-%, especially preferably of from 15 to 35 wt.-%, based in each case on the total solids content of the electrodeposition coating composition. Alternatively, in case the electrodeposition coating composition of the invention additionally includes at least one crosslinking agent component (c), said component (c) is preferably present in an amount in a range of from 0.5 to 30 wt.-%, more preferably of from 1 to 25 wt.-%, very preferably of from 1.5 to 20 wt.-%, more particularly of from 2 to 17.5 wt.-%, most preferably of from 2.5 to 15 wt.-%, especially preferably of from 3 to 10 wt.-%, based in each case on the total weight of the electrodeposition coating material composition, respectively the coating bath.

The fractions in wt.-% of all of the components (a), (b) and water included in the electrodeposition coating composition of the invention, and also of further components that may be present additionally, for example component (c), add up to 100 wt.-%, based on the total weight of the electrodeposition coating material composition.

The relative weight ratio of components (a) and (c)—if component (c) is present—to one another in the electrodeposition coating material composition is preferably in a range of from 5:1 to 1.1:1, more preferably in a range of from 4.5:1 to 1.1:1, very preferably in a range of from 4:1 to 1.2:1, more particularly in a range of from 3:1 to 1.5:1.

The inventive composition comprises at least one, preferably exactly one, binder dispersion (I). As known to the person skilled in the art, electrodeposition coating compositions regularly contain such a binder dispersion, i.e. an aqueous dispersion comprising at least one polymer as binder. Also, the inventive composition contains at least one pigment paste (II). Again, as known by the skilled person in the art, electrodeposition coating compositions regularly contain such pigment pastes.

In the following, different essential and optional components of the inventive compositions are described. More details on the binder dispersions (I) and pigment pastes (II) will also follow further below.

### Component (a)

Component (a) is at least one cathodically depositable polymer, which preferably functions as at least one binder in the inventive electrodeposition coating material composition. Simultaneously, component (a) may also function as grinding resin as it will be outlined hereinafter in more detail.

Any polymer is suitable as binder and thus as component (a) as long as it is cathodically depositable. Preferred are poly(meth)acrylates, (meth)acrylate copolymers, and epoxide polymers.

Preferably, component (a) of the electrodeposition coating composition of the invention comprises and/or is at least one epoxide-amine adduct.

An epoxide-amine adduct for the purposes of the present invention is a reaction product of at least one epoxy resin and at least one amine. Epoxy resins used are more particularly those based on bisphenol A and/or derivatives thereof. Amines reacted with the epoxy resins are primary and/or secondary amines or salts thereof and/or salts of tertiary amines.

The at least one epoxide-amine adduct used as component (a) is preferably a cationic, epoxide-based and amine-modified resin. The preparation of such cationic, amine-modified, epoxide-based resins is known and is described for example in DE 35 18 732, DE 35 18 770, EP 0 004 090, EP 0 012 463, EP 0 961 797 B1, and EP 0 505 445 B1. Cationic, epoxide-based, amine-modified resins are understood preferably to be reaction products of at least one polyepoxide having preferably two or more, e.g., three, epoxide groups, and at least one amine, preferably at least one primary and/or secondary amine. Particularly preferred polyepoxides are polyglycidyl ethers of polyphenols that are prepared from polyphenols and epihalohydrins. Polyphenols used may in particular be bisphenol A and/or bisphenol F. Other suitable polyepoxides are polyglycidyl ethers of polyhydric alcohols, such as, for example, of ethylene glycol, diethylene glycol, triethylene glycol, propylene 1,2-glycol, propylene 1,4-glycol, 1,5-pentanediol, 1,2,6-hexanetriol, glycerol, and 2,2-bis(4-hydroxycyclohexyl)propane. The polyepoxide used may also be a modified polyepoxide. Modified polyepoxides are understood to be those polyepoxides in which some of the reactive functional groups have been reacted with at least one modifying compound. Examples of such modifying compounds are as follows:
i) compounds containing carboxyl groups, such as saturated or unsaturated monocarboxylic acids (e.g., benzoic acid, linseed oil fatty acid, 2-ethylhexanoic acid, Versatic acid), aliphatic, cycloaliphatic and/or aromatic dicarboxylic acids of various chain lengths (e.g., adipic acid, sebacic acid, isophthalic acid, or dimeric fatty acids), hydroxyalkyl carboxylic acids (e.g., lactic acid, dimethylolpropionoic acid), and carboxyl-containing polyesters, or
ii) compounds containing amino groups, such as diethylamine or ethylhexylamine or diamines with secondary amino groups, e.g., N,N′-dialkylalkylenediamines, such as dimethylethylenediamine, N,N′-dialkyl-polyoxyalkyleneamines, such as N,N′-dimethylpolyoxypropylenediamine, cyanoalkylated alkylenediamines, such as bis-N,N′-cyanoethylethylenediamine, cyanalkylated polyoxyalkyleneamines, such as bis-N,N′-cyanoethylpolyoxypropylenediamine, polyaminoamides, such as, for example, Versamides, especially amino-terminated reaction products of diamines (e.g., hexamethylenediamine), polycarboxylic acids, especially dimer fatty acids and monocarboxylic acids, more particularly fatty acids, or the reaction product of one mole of diaminohexane with two moles of monoglycidyl ether or monoglycidyl ester, especially glycidyl esters of α-branched fatty acids, such as Versatic acid, or
iii) compounds containing hydroxyl groups, such as neopentyl glycol, bisethoxylated neopentyl glycol, neopentyl glycol hydroxypivalate, dimethylhydantoin-N,N′-diethanol, hexane-1,6-diol, hexane-2,5-diol, 1,4-bis(hydroxymethyl)cyclohexane, 1,1-iso-propylidenebis(p-phenoxy)-2-propanol, trimethylolpropane, pentaerythritol or amino alcohols, such as triethanolamine, methyldiethanolamine, or hydroxyl-group-containing alkylketimines, such as aminomethylpropane-1,3-diol methylisobutylketimine or tis(hydroxymethyl)aminomethane cyclohexanoneketimine, and also polyglycol ethers, polyester polyols, polyether polyols, polycaprolactone polyols, polycaprolactam polyols of various functionalities and molecular weights, or
iv) saturated or unsaturated fatty acid methyl esters, which are esterified with hydroxyl groups of the epoxy resins in the presence of sodium methoxide.

Examples of amines which can be used for preparing component (a) are mono- and dialkylamines, such as methylamine, ethylamine, propylamine, butylamine, dimethylamine, diethylamine, dipropylamine, methylbutylamine, alkanolamines, such as methylethanolamine or diethanolamine, dialkylaminoalkylamines, such as dimethylaminoethylamine, diethylaminopropylamine, or dimethylaminopropylamine, for example. The amines which can be used may also include other functional groups as well, provided they do not disrupt the reaction of the amine with the epoxide group of the optionally modified polyepoxide and also do not lead to gelling of the reaction mixture. Secondary amines are preferably used. The charges that are needed for dilutability with water and for electrical deposition may be generated by protonation with water-soluble acids (e.g., boric acid, formic acid, acetic acid, lactic acid, alkylsulfonic acids (e.g. methanesulfonic acid)); preferably acetic acid and/or formic acid). A further way of introducing cationic groups into the optionally modified polyepoxide is to react epoxide groups of the polyepoxide with amine salts.

The epoxide-amine adduct which can be used as component (a) is preferably a reaction product of an epoxy resin based on bisphenol A and primary and/or secondary amines or salts thereof and/or the salt of a tertiary amine.

### Component (b)

The electrodeposition coating material composition of the invention comprises at least one alkoxylated polyethyleneimine. Preferably, exactly one kind of alkoxylated polyethyleneimine is comprised.

Polyethyleneimines are well-known to the person skilled in the art.

Polyethyleneimines are polymers with repeating units formally composed of reacted aziridine molecules, i.e. amin functions separated by ethylene (—CH₂—CH₂—) spacer units. In case of linear polyethyleneimines the amino groups within the chain are all secondary amino groups, while in branched polyethyleneimines, depending on the branching character and its extent, also tertiary amino groups (then depicting the branching points) are present within the molecule. Chain/polymer termination, quite obviously, results in primary amino groups.

Synthesis methods of such polyethyleneimines are also well-known and may be conducted by ring opening polymerization of aziridine. Varying reaction conditions lead to different degrees of branching. For details, it is referred to the widely known and available established scientific literature and common knowledge.

The polyethyleneimine (b) is an alkoxylated polyethyleneimine. Accordingly, N—H functions of the primary and secondary amino groups present in a polyethyleneimines as such are modified and reacted by means of suitable components to result in respective alkoxylation. As an example, the nucleophilic center of the amino groups (N—H functions) may be reacted with ethylene oxide (oxirane), leading to an alkoxylation (here ethoxylation) of the polyethyleneimine via ring opening polymerization of ethylene oxide.

The degree of alkoxylation (i.e. the average number of polymerized alkoxy moieties (i.e. O-alkyl-moieties) per alkoxylation modification on amino groups) as well as the statistical distribution of the size and length of the individual alkoxylation modifications of amino groups depends on the stoichiometric conditions and also reaction conditions. Again, for details it is referred to well-known scientific literature and knowledge of the person skilled in the art.

Apparently, each alkoxylation modification consumes one protic N—H function, thus leading from a primary amino group to a secondary amino group or from a secondary amino group to a tertiary amino group.

As tertiary amino groups are normally more alkaline than primary and secondary amino groups, a tendency of the overall molecule to be more protonated at a given pH value results. More specifically, a certain protonation already may be achieved at pH values which are preferred in the context of electrodeposition coating materials, e.g. at pH values of for example 3.5 to 7.0 or 4.0 to 6.5 (i.e. pH values which, on the one hand side, guarantee a protonated state of dispersed binder polymers preferably applied in the context of cathodically depositable coating materials, meaning that these polymers are stabilized in the dispersion and migrate to the cathode when a current is applied and on the other hand allow the deposition on the substrate without any defects or for example re-dissolution of material. Therefore, regarding water dispersibility, the existence of these amino groups is of advantage due to their protonation behavior at pH conditions being suitable for cathodically depositable coating materials.

Preferably, the alkoxylated polyethyleneimine (b) is of branched character, i.e. the polyethyleneimine moiety of the component (b) is a branched polyethyleneimine moiety. Accordingly, it comprises (also) tertiary amino groups due to the branched character, even if, alone for statistical reasons, may still contain secondary and primary amino groups. Furthermore, the branched character of the polyethylene moiety may result in an at least partly globular, dendric structure. This, in turn, is equivalent to a comparably compact molecule core of branched polyethyleneimine moieties and a shell-like structure comprising multiple well accessible N—H functions for alkoxylation.

Preferably, the at least one alkoxylated polyethyleneimine (b) is an ethoxylated, a propoxylated and/or a mixed ethoxylated/propoxylated polyethyleneimine. More preferably, the at least one alkoxylated polyethyleneimine (b) is an ethoxylated polyethyleneimine. While both prementioned types of alkoxylation are well available and conveniently feasible, they also contribute to enhanced water dispersibility (which is important in the context of the inventive aqueous electrodeposition coating material). This, in particular, is the case for ethoxylated polyethyleneimines. Furthermore, for example they may exhibit a steric effect as a shell-like structure, influencing the interaction with the inventive electrodeposition coating material and the alkalinity of the amine functions of the alkoxylated polyethyleneimine (b), ensuring a compatibility with the other components of the inventive electrodeposition coating material, for example component (a). Thus, an insufficient degree of or missing alkoxylation may result in an incompatibility with the electrodeposition coating, resulting, for example, in instabilities of the coating material bath.

The degree of alkoxylation (i.e. the average number of polymerized alkoxy moieties (i.e. O-alkyl-moieties) per alkoxylation modification on amino groups) may preferably be chosen in a range of from 5 to 100, more preferably 10 to 90 or 15 to 70. Within these ranges of alkoxylation, it is clear that alone for statistical reasons a high share (or even all) of the N—H functions are consumed by an alkoxylation modification, meaning that the above mentioned effects (low amount of N—H functions, high water dispersibility at pH values being greatly suitable in the context of cathodically depositable coating materials, core-shell like structures, steric effects etc.) are reached to a great extent.

The degree of alkoxylation is determined via 13C NMR spectroscopy and comparison of signal intensities of (i) the carbon signals assignable to the alkyl-O units of the alkoxylation (e.g. (CH2-CH2-O) in an ethoxylated type) and (ii) the carbon signal assignable to the carbon in alpha position to the hydroxyl end group of such an alkoxylation.

The number averaged molecular weight (Mn) of the alkoxylated polyethyleneimine (b) may range, for example from 1000 to 30000 g/mol, like from 2500 to 25000 g/mol, preferably from 5000 to 20000 g/mol or even from 7500 to 15000 g/mol. The number average molecular weight is determined via gel permeation chromatography (eluent tetrahydrofurane/triethylamine (0.5 vol.-%), calibration against polymethyl-methacrylate standard).

Component (b) may be applied in form of an aqueous dispersion or solution. Accordingly, such a dispersion or solution is added during production of the binder dispersion (I) and/or the pigment paste (II).

As component (b) itself contains a significant portion of basic amino groups, it is clear that mixing it with just water ultimately leads to an increase of pH into the basic range. Therefore, to eventually realize the above stated preferred pH values and ranges of the inventive compositions, addition of acid might be required. Preferred are water-soluble acids as known in the art and as mentioned before, e.g. acetic acid or methane sulfonic acid, to introduce acidity. By this means, an equilibrium state results which includes at least a partly protonated amino group portion of component (b) in water.

Components (b), in particular preferred components (b) being ethoxylated and branched polyethyleneimines, are, for example, available as commercial products under the trade name Sokalan HP, for example Sokalan HP20®.

While these commercially available products are offered for applications like laundry, dishwashing and cleaning, it is remarkably surprising that they also have significant positive influence on edge corrosion protection of electrodeposition coating materials as outlined in the introductory part.

Optional component (c)

At least one crosslinking agent can be present in the electrodeposition coating material composition as component (c), which is selected from the group consisting of blocked polyisocyanates, free polyisocyanates, amino resins, and mixtures thereof. Said component (c) is different from component (a).

The term “blocked polyisocyanates” is known to the skilled person. Blocked polyisocyanates which can be utilized are polyisocyanates having at least two isocyanate groups (diisocyanates in case of precisely two isocyanate groups), but preferably having more than two, such as, for example, 3 to 5 isocyanate groups, wherein the isocyanate groups have been reacted, so that the blocked polyisocyanate formed is stable in particular with respect to hydroxyl groups and amino groups such as primary and/or secondary amino groups at room temperature, i.e., at a temperature of 18 to 23° C., but at elevated temperatures, as for example at ≥80° C., ≥110° C., ≥130° C., ≥140° C., ≥150° C., ≥160° C., ≥170° C., or ≥180°, reacts with conversion and with formation of urethane and/or urea bonds, respectively.

In the preparation of the blocked polyisocyanates it is possible to use any desired organic polyisocyanates suitable for crosslinking. Isocyanates used preferably are (hetero)aliphatic, (hetero)cycloaliphatic, (hetero)aromatic or (hetero)aliphatic-(hetero)aromatic isocyanates. Preferred polyisocyanates are those containing 2 to 36, especially 6 to 15, carbon atoms. Preferred examples are ethylene 1,2-ethylene diisocyanate, tetramethylene 1,4-diisocyanate, hexamethylene 1,6-diisocyanate (HDI), 2,2,4(2,4,4)-tri-methylhexamethylene 1,6-diisocyanate (TMDI), diphenylmethane diisocyanate (MDI), 1,9-diisocyanato-5-methylnonane, 1,8-diisocyanato-2,4-dimethyloctane, dodecane 1,12-diisocyanate, ω,ω′-di-isocyanatodipropyl ether, cyclobutene 1,3-diisocyanate, cyclohexane 1,3- and 1,4-diisocyanate, 3-isocyanatomethyl-3,5,5-trmethylcyclohexyl isocyanate (isophorone diisocyanate, IPDI), 1,4-diisocyanatomethyl-2,3,5,6-tetramethyl-cyclohexane, decahydro-8-methyl(1,4-methanonaphthalen-2 (or 3),5-ylenedimethylene diisocyanate, hexahydro-4,7-methanoindan-1 (or 2),5 (or 6)-ylenedimethylene diisocyanate, hexahydro-4,7-methanoindan-1 (or 2),5 (or 6)-ylene diisocyanate, hexahydrotolylene 2,4- and/or 2,6-diisocyanate (H6-TDI), toluene 2,4- and/or 2,6-diisocyanate (TDI), perhydrodiphenylmethane 2,4′-diisocyanate, perhydrodiphenylmethane 4,4′-diisocyanate (H12MDI), 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-di-isocyanatomethyl-2,3,5,6-tetramethylbenzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, 2,5(2,6)-bis(isocyanatomethyl)bicyclo[2.2.1]heptane (NBDI), and also any mixture of these compounds. Polyisocyanates of higher isocyanate functionality may also be used. Examples thereof are trimerized hexamethylene diisocyanate and trimerized isophorone diisocyanate, more particularly the corresponding isocyanurates. It is also possible, furthermore, to utilize mixtures of polyisocyanates.

For the blocking of the polyisocyanates it is possible with preference to use any desired suitable aliphatic, cycloaliphatic, or aromatic alkyl monoalcohols. Examples thereof are aliphatic alcohols, such as methyl, ethyl, chloroethyl, propyl, butyl, amyl, hexyl, heptyl, octyl, nonyl, 3,3,5-trimethylhexyl, decyl, and lauryl alcohol; cycloaliphatic alcohols, such as cyclopentanol and cyclohexanol; aromatic alkyl alcohols, such as phenylcarbinol and methylphenylcarbinol. Likewise, suitable diols such as ethanediol, 1,2-propanediol, 1,3-propanediol and/or polyols may also be used for blocking of the polyisocyanates. Other suitable blocking agents are hydroxylamines, such as ethanolamine, oximes, such as methyl ethyl ketone oxime, acetone oxime, and cyclohexanone oxime, and amines, such as dibutylamine and diisopropylamine.

Tris(alkoxycarbonylamino)-1,3,5-triazine (TACT) are likewise known to the skilled person. The use of tris(alkoxycarbonylamino)-1,3,5-triazines as crosslinking agents in coating material compositions is known. For example, DE 197 12 940 A1 describes the use of such crosslinking agents in basecoat materials. U.S. Pat. No. 5,084,541 describes the preparation of corresponding compounds which can be used as component (c). Such triazines are for the purposes of the present invention to be encompassed by the term “blocked polyisocyanates”.

Amino resins (aminoplast resins) are likewise known to the skilled person. Amino resins used are preferably melamine resins, more particularly melamine-formaldehyde resins, which are likewise known to the skilled person. Preference, however, is given to using no amino resins such as melamine-formaldehyde resins as crosslinking agents (c). The electrodeposition coating material composition of the invention therefore preferably comprises no amino resins such as melamine-formaldehyde resins.

The electrodeposition coating material composition of the invention is used preferably as a one-component (1K) coating composition. For this reason, the electrodeposition coating composition of the invention preferably contains no free polyisocyanates.

Pigments and/or Fillers

The electrodeposition coating material composition of the invention comprise at least one pigment and/or at least one filler.

The term “pigment” is known to the skilled person, from DIN 55943 (date: October 2001), for example. A “pigment” in the sense of the present invention refers preferably to a component in powder or flake form which is substantially, preferably entirely, insoluble in the medium surrounding them, such as the electrodeposition coating material composition of the invention, for example. Pigments are preferably colorants and/or substances which can be used as pigment on account of their magnetic, electrical and/or electromagnetic properties. Pigments differ from “fillers” preferably in their refractive index, which for pigments is ≥1.7.

The term “filler” is known to the skilled person, from DIN 55943 (date: October 2001), for example. “Fillers” for the purposes of the present invention preferably are components, which are substantially, preferably entirely, insoluble in the application medium, such as the electrodeposition coating material composition of the invention, for example, and which are used in particular for increasing the volume. “Fillers” in the sense of the present invention preferably differ from “pigments” in their refractive index, which for fillers is <1.7.

Any customary pigment known to the skilled person may be used. Examples of suitable pigments are inorganic and organic coloring pigments. Examples of suitable inorganic coloring pigments are white pigments such as titanium dioxide, zinc white, zinc sulfide or lithopone; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate. Further inorganic coloring pigments are silicon dioxide, aluminum oxide, aluminum oxide hydrate, especially boehmit, titanium dioxide, zirconium oxide, cerium oxide, and mixtures thereof. Examples of suitable organic coloring pigments are monoazo pigments, disazo pigments, anthraquinone pigments, benzimidazole pigments, quinoacridone pigments, quinophthalone pigments, diketopyrrolopyrrol pigments, dioxazine pigments, indanthrone pigments, isoindoline pigments, isoindolinone pigments, azomethine pigments, thioindigo pigments metal complex pigments, perinone pigments, perylene pigments, phthalocyanine pigments or aniline black.

Any customary filler known to the skilled person may be used. Examples of suitable fillers are kaolin, dolomite, calcite, chalk, calcium sulfate, barium sulfate, graphite, silicates such as magnesium silicates, especially corresponding phyllosilicates such as hectorite, bentonite, montmorillonite, talc and/or mica, silicas, especially fumed silicas, hydroxides such as aluminum hydroxide or magnesium hydroxide. As examples of kaolin, commercial products like ASP 200 (non-calcined kaolin, Fa. BASF) or KaMin 2000C (calcined kaolin, Fa. KaMin) may be mentioned (with a preference on ASP 200). Also, organic fillers such as textile fibers, cellulose fibers, polyethylene fibers or polymer powders may be applied. For further details, reference is made to Römpp Lexikon Lacke und Druckfarben, Georg Thieme Verlag, 1998, pages 250 ff., “Fillers”.

The pigment plus filler content, based on the total weight of the electrodeposition material coating composition of the invention, is preferably in the range of from 0.1 to 20.0 wt.-%, more preferably of from 0.1 to 15.0 wt.-%, very preferably of from 0.1 to 10.0 wt.-%, especially preferably of from 0.1 to 5.0 wt.-%, and more particularly of from 0.1 to 2.5 wt.-%.

The pigment and/or filler is incorporated in the form of a pigment paste (II) into the electrodeposition coating material composition. It is possible and preferred that one pigment paste (II) comprises both one or more pigments and/or fillers. Such pastes typically include at least one polymer used as grinding resin. Preferably, therefore, there is at least one such polymer used as grinding resin included in the electrodeposition coating composition of the invention. It is possible that the at least one polymer (a) used as binder in the electrodeposition coating material composition can also additionally function as grinding resin in the pigment paste (II). The grinding resin in question is preferably an epoxide-amine adduct, which as outlined above may correspond to and/or can be subsumed under the definition of component (a). The polymer used as grinding resin preferably has building blocks which interact with the surfaces of the pigments. The grinding resins therefore preferably have the effect of an emulsifier. In many cases quaternary ammonium compounds are incorporated for the purpose of improving the grinding resin properties. Besides the grinding resins, further customary additives like wetting agents or dispersants (optional components (e) as described below) and also solvents (water and organic co-solvents) may be comprised. The production of the pigment paste includes a grinding/milling step. Thereby, the pigments and/or fillers are preferably ground together with a grinding resin and the further components/solvents to form a pigment paste. Often, also a catalyst (optional component (d) as described below) is added before the grinding/milling step to ensure an appropriate integration and effectiveness of the catalyst. To produce the finished electrodeposition coating material composition, this paste is mixed with the rest of the constituents, in particular the binder dispersion (I). The use of a pigment paste leads advantageously to a greater flexibility in electrodeposition coating, since the pigment/filler and binder of the electrodeposition coating material composition can be readily adapted at any time to the requirements of practice via the amount of the pigment paste.

As mentioned above, in one embodiment of the invention the pigment paste (II) contains at least one component (b). The polyethyleneimine (b) may be added, in principle, at any position and time of the preparation of the pigment paste, e.g. before or after grinding/milling. It is, however, preferred that component (b) is added before the grinding/milling step. Often, production of pigment pastes involves addition of all non-solid components (i.e. liquid components), before solid components (in particular pigments and fillers and also catalysts) are added and then grinded/milled. It has been observed that it may be of advantage to add the polyethyleneimine (b) directly before the first addition of a solid component. After addition of all components, the grinding/milling takes place.

### Further Optional Components

The electrodeposition coating material composition of the invention preferably includes at least one component (d) a catalyst such as, for example, a metal-containing catalyst like in particular a tin- or bismuth-containing catalyst. The catalyst optionally included is even more preferably a bismuth-containing catalyst. With particular preference it is possible to use a bismuth-containing catalyst, such as, for example, bismuth(III) oxide, basic bismuth(III) oxide, bismuth(III) hydroxide, bismuth(III) carbonate, bismuth(III) nitrate, bismuth(III) subnitrate (basic bismuth(III) nitrate), bismuth(III) salicylate and/or bismuth(III) subsalicylate (basic bismuth(III) salicylate), and also mixtures thereof. Especially preferred are water-insoluble, bismuth-containing catalysts. Preferred more particularly is bismuth(III) subnitrate. The electrodeposition coating material composition of the invention preferably includes at least one bismuth-containing catalyst in an amount such that the bismuth(III) content, calculated as bismuth metal, based on the total weight of the electrodeposition coating material of the invention, is in a range from 10 ppm to 20 000 ppm. The amount of bismuth, calculated as metal, may be determined by means of inductively coupled plasma-atomic emission spectrometry (ICP-OES) in accordance with DIN EN ISO 11885 (date: September 2009).

Depending on desired application, the electrodeposition coating material composition of the invention may comprise one or more commonly employed further additives as one or more optional components (e). Component (e) is different from any of components (a) to (d). Preferably, these additives are selected from the group consisting of wetting agents, emulsifiers, dispersants, surface-active compounds such as surfactants, flow control assistants, solubilizers, defoamers, rheological assistants, antioxidants, stabilizers, preferably heat stabilizers, process stabilizers, and UV and/or light stabilizers, flexibilizers, plasticizers, and mixtures of the aforesaid additives. The additive content may vary very widely according to intended use. The additive content, based on the total weight of the electrodeposition material coating composition of the invention, is preferably in the range of from 0.1 to 20.0 wt.-%, more preferably of from 0.1 to 15.0 wt.-%, very preferably of from 0.1 to 10.0 wt.-%, especially preferably of from 0.1 to 5.0 wt.-%, and more particularly of from 0.1 to 2.5 wt.-%.

As mentioned above, the inventive composition contains at least one binder dispersion (I). The binder dispersion (I) contains at least one component (a). Also, the binder dispersion (I) regularly contains further optional components mentioned above, in particular component (c). Also, different components (d) and are regularly comprised. Besides water, also further organic co-solvents may be part of the binder dispersion (I).

In a preferred embodiment, the binder dispersion (I) contains at least one component (e) selected from the group of polymeric softeners and surface-active additives. Preferred polymeric softeners are, for example, alkoxylated bisphenols like in particular alkoxylated bisphenol A, preferably ethoxylated bisphenol A. Preferred surface-active additives are polydimethylsiloxanes like, for example, Polydimethylsiloxane-poly(ethylene oxid-co-propylene oxid)-copolymers. In a preferred embodiment, both prementioned components (e) are comprised in binder dispersion (I).

As mentioned above, in one embodiment of the invention the binder dispersion (I) contains at least one component (b). The polyethyleneimine (b) may be added, in principle, at any position and time of the preparation of the binder dispersion (I). As is known, production of a binder dispersion containing a polymer (a), water and also further components like for example components (c) or (e) and organic solvents, involves different steps of addition of components in an individual order, whereby within the procedure of addition one or more intermediate and/or final stirring and/or dispersing steps are included. The polyethyleneimine (b), for example, may be introduced as the first or one of the first components. Also, the polyethyleneimine (b) may be added at an intermediate position before or after an intermediate dispersing step. Quite obviously, it may also be added at the final position, for example directly before the final stirring/dispersing step or even thereafter. Preferably, the polyethyleneimine (b) is added at a position before at least one further dispersing step is conducted.

### Kit of Parts

A further subject of the present invention is a kit of parts for manufacturing an aqueous cathodically depositable electrodeposition coating material composition, comprising
(I) at least one binder dispersion comprising at least one cathodically depositable polymer (a) and
(II) at least one pigment paste comprising at least one pigment and/or filler,
wherein at least one alkoxylated polyethyleneimine (b) is part of the at least one binder dispersion (I) and/or part of the at least one pigment paste (II).

Accordingly, the kit of parts comprises at least two different parts, namely the binder dispersion (I) and the pigment paste (II). At least one of these separate parts comprise a polyethyleneimine (b).

The present invention also comprises a method of manufacturing a cathodically depositable electrodeposition coating material composition comprising
provision of (I) at least one binder dispersion comprising at least one cathodically depositable polymer (a)
provision of at least one pigment paste (II) comprising at least one pigment and/or filler,
wherein the binder dispersion (I) and/or the pigment paste (II) comprises at least one alkoxylated polyethyleneimine (b),
mixing the binder dispersion (I), the pigment paste (II) and any further potential components of the composition.

Quite obviously, any and all essential and also preferred features and embodiments mentioned above in the context of the inventive composition likewise apply for the kit of parts and method of manufacturing.

### Method for Electrocoating

A further subject of the present invention is a method for at least partially coating an electrically conductive substrate by cathodic electrodeposition coating comprising at least steps (1) to (5), namely
(1) immersing of the electrically conductive substrate at least partially into an electrodeposition coating bath, which comprises the inventive electrodeposition coating material composition,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

All preferred embodiments described hereinabove in connection with the electrodeposition coating material composition of the invention are also preferred embodiments with regard to the aforesaid method of the invention using this electrodeposition coating material composition for at least partially coating an electrically conductive substrate by cathodic electrodeposition coating.

Preferably, the above-mentioned method comprises, between step (4) and (5), a step (4.1) of rinsing the coated substrate, for example with DI water. This step, quite obviously, serves the cleaning of the substrate, i.e. removal of residual coating material not being well deposited on the substrate.

The method of the invention is particularly suitable for the electrodeposition coating of automotive vehicle bodies or parts thereof including respective metallic substrates. Consequently, the preferred substrates are automotive vehicle bodies or parts thereof. As the inventive electrodeposition coating material composition is particularly useful for gaining excellent edge protection, as a preferred embodiment, metallic substrates having comparably many of such edges are to be named. Such substrates, in particular, are metallic automotive component parts like, for example, transverse control arms, spring-loaded control arms or dampers. Such component parts may be cast iron parts or may also be produced by other established methods known in the art. Further such substrates are metallic automotive bodies, for example automotive bodies that were partly stamped to cut out specific parts or form specific geometries and thus also comprise comparably many edges. Accordingly, in one preferred embodiment of the present invention the substrate is selected from the prementioned substrates having many edges.

As also already described above, the remarkable edge protection effected by the present invention is particularly useful in the context of metallic substrates having at least partly edges which were not post processed, like, for example, sanded or polished, meaning that these edges remain comparably sharp. Accordingly, in another preferred embodiment of the present invention the substrate is selected from the prementioned substrates having edges which were at least partly not post processed like, for example, sanded or polished or treated otherwise to reduce the edges, furthermore, referred to as not sanded or polished.

Suitability as electrically conductive substrate used in accordance with the invention are all electrically conductive substrates used customarily and known to the skilled person. The electrically conductive substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production.

Before the respective electrically conductive substrate is used in step (1) of the inventive method, it is preferably cleaned and/or degreased.

The electrically conductive substrate used in accordance with the invention is preferably a pretreated substrate, for example pretreated with at least one metal phosphate such as zinc phosphate. A pretreatment of this kind by means of phosphating, which takes place normally after the substrate has been cleaned and before the substrate is electrodeposition-coated in step (1), is in particular a pretreatment step that is customary in the automobile industry. Pretreatment methods other than phosphating are, however, also possible, for example a thin film pretreatment based on zirconium oxide or typical silanes.

During performance of steps (1), (2), and (3) of the method of the invention, the electrodeposition coating material composition of the invention is deposited cathodically on the region of the substrate immersed into the bath in step (1). In step (2), the substrate is connected as the cathode, and an electrical voltage is applied between the substrate and at least one counterelectrode, which is located in the deposition bath or is present separately from it, for example by way of an anion exchange membrane which is permeable for anions. The counterelectrode functions, accordingly, as an anode. On passage of electrical current between anode and cathode, a firmly adhering coating film is deposited on the cathode, i.e., on the immersed part of the substrate. The voltage applied here is preferably in a range from 50 to 500 volts. On performance of steps (1), (2), and (3) of the method of the invention, the electrodeposition coating bath preferably has a bath temperature in a range from 20 to 45° C.

The baking temperature in step (5) is preferably in a range from 100 to 210° C., more preferably from 120 to 205° C., very preferably from 120 to 200° C., more particularly from 125 to 195° C. or from 125° C. to 190° C., most preferably from 130 to 185° C. or from 140 to 180° C.

After having performed step (5) of the inventive method one or more further coating layers can be applied onto the baked coating film obtained after step (5). For example, a primer and/or filler can be applied, followed by a basecoat and a clearcoat.

Therefore, the inventive method preferably comprises at least one further step (6), namely

(6) applying at least one further coating material composition, which is different from the composition applied in step (1), at least partially onto the baked coating film obtained after step (5).

### Substrate

A further subject of the present invention is an electrically conductive substrate which is coated at least partially with a baked electrodeposition coating material of the invention. The baked coating material corresponds to the baked coating film obtained after step (5) of the inventive method.

All preferred embodiments described hereinabove in connection with the electrodeposition coating material composition of the invention and the method of the invention are also preferred embodiments with regard to the aforesaid at least partially coated substrate of the invention.

Of course, also a baked electrodeposition coating layer produced from an inventive electrodeposition coating material composition is a subject of the present invention.

methods

### 1. Determining the Non-Volatile Fraction

The nonvolatile fraction (the solids or solids content) is determined in accordance with DIN EN ISO 3251 (date: June 2019). This involves weighing out 1 g of sample into an aluminum dish which has been dried beforehand and drying the dish with sample in a drying cabinet at 180° C. for 30 minutes, cooling it in a desiccator, and then reweighing. The residue, relative to the total amount of sample employed, corresponds to the nonvolatile fraction (in % or wt.-%)

### 2. VDA Climate Change Test (DIN EN ISO 11997-1: 2018-01)

This climate change test is used to determine the corrosion resistance of a coating on a substrate. The climate change test is carried out in 10 or 20 so-called cycles.

If the coating to be tested is present on a metallic substrate having holes, these holes simulate a real-life metallic substrate having a comparably high number of edges/edge zones. Also, in case of substrates having holes whose edges are not post processed, like, for example, sanded or polished before any pretreatment and coating processes start, these substrates are even more challenging in terms of coating and thus corrosion edge protection. The degree of corrosion on the edges of these holes (also called “edges of holes corrosion” or “edge corrosion”) may be assessed visually by observing the degree/portion of the hole edge being corroded after the climate change test (Rating scale from 1 to 5, wherein “5” means 100% corrosion (the whole edge of the hole is corroded) and “1” means 0% corrosion).

If the coating of the samples to be tested is scored down to the substrate with a knife cut before the climate change test is performed, the samples can be tested for their degree of under-film corrosion in accordance with DIN EN ISO 4628-8 (03-2013), since the substrate corrodes along the scoring line during the climate change test. As corrosion progresses, the coating is more or less infiltrated during the test. The degree of undermining in [mm] is a measure of the corrosion resistance of the coating (also called scribe corrosion).

Each rating result shown further below is the average of 3 to 5 individual test results. Each individual test result was generated by means of an individual panel (i.e. coated test substrate), whereby each individual panel exhibited seven individual holes. The individual test result of one individual panel on edges of holes protection thus itself is an average of analysis of the seven individual holes.

3. Salt spray test

The corrosion resistance of coatings may also be determined by a salt spray test. The salt spray testing is carried out according to DIN EN ISO 9227 NSS (date: September 2012) for the coated substrate under study. The samples under study are accommodated in a chamber in which at a temperature of 35° C.—continuously over duration of 1008 hours or 2016 hours—a mist is produced from a 5% strength sodium chloride solution with a controlled pH in the range from 6.5 to 7.2. The mist deposits on the samples under study and covers them with a corrosive saltwater film.

If the coating to be tested is present on a metallic substrate having holes, these holes resemble a real-life metallic substrate having a comparably high number of edges/edge zones. Also, in case of substrates having holes whose edges are not sanded/polished before any pretreatment and coating processes start, these substrates resemble respective substrates having a high number of edges/edge zones which were not sanded/polished, thus being even more challenging in terms of coating and thus corrosion edge protection. The degree of corrosion on edge of these holes (also called “edges of holes corrosion” or “edge corrosion”) may be assessed visually by observing the degree/portion of the hole edge being corroded after the climate change test (Rating scale from 1 to 5, wherein “5” means 100% corrosion (the whole edge of the hole is corroded) and “1” means 0% corrosion).

If prior to the salt spray testing according to DIN EN ISO 9227 NSS, the coating on the samples under study is scored down to the substrate with a blade incision, the samples can be investigated for their level of corrosive undermining to DIN EN ISO 4628-8 (03-2013), since the substrate corrodes along the score line during the DIN EN ISO 9227 NSS salt spray testing. As a result of the progressive process of corrosion, the coating is undermined to a greater or lesser extent during the test. The extent of undermining in [mm] is a measure of the resistance of the coating to corrosion (also called scribe corrosion).

Each rating result shown further below is the average of 3 to 5 individual test results. Each individual test result was generated by means of an individual panel (i.e. coated test substrate), whereby each individual panel exhibited seven individual holes. The individual test result of one individual panel on edges of holes protection thus itself is an average of analysis of the seven individual holes.

### 4. Surface Roughness

The surface roughness is determined according to DIN EN 10049:2014-03. Lower values [Micrometer], quite obviously, reflect a lower surface roughness and thus better coating smoothness and homogeneity.

Each rating result shown further below is the average of 3 to 5 individual test results. Each individual test result was generated by means of an individual panel (i.e. coated test substrate).

### EXAMPLES

The following examples further illustrate the invention but are not to be construed as limiting its scope.

### 1. Preparation of Aqueous Cathodically Depositable Electrodeposition Coating Material Compositions

### 1.1 Pigment Pastes (II)

A standard pigment paste P1 customary used in the preparation of aqueous cathodically depositable electrodeposition coating material compositions was prepared by (i) mixing respective constituents in a dissolver and (ii) milling the mixture from (i) using a standard mill under customary conditions. Thereby, within step (i) all liquid constituents were added, before then the solid components were introduced.

Pigment paste P1 comprises, as grinding resin, an aqueous dispersion of an epoxy-amine adduct (a component (a), solids content 40.4%). Also, paste P1 comprises bismuth(III) subsalicylate as a catalyst, carbon black as a black pigment, kaolin (ASP 200) as a filler and also further constituents, in particular water and additives customary for aqueous cathodically depositable electrodeposition coating material compositions. The solids content of pigment paste P1 is 62.0%.

Furthermore, a pigment paste P2 was prepared. The preparation, in principle, was conducted as for paste P1. However, as last position of liquid components, Sokalan® HP20 (Fa. BASF) (component (b), solids content of 80-82%) was added. The effective amount of component (b) is 2 wt.-%, based on the total weight of pigment paste P2.

Sokalan® HP20 (Fa. BASF) is a branched ethoxylated polyethyleneimine having a degree of ethoxylation of 28 and a number averaged molecular weight of 8600 g/mol (measurements methods cf. detailed description of the invention above).

### 1.2 Binder Dispersions (I)

As a standard binder dispersion (I), a system B1 customary applied in electrodeposition coating material compositions was used. The binder dispersion contained an aqueous dispersion of an epoxy-amine adduct as binder resin (also a component (a) but being different from the epoxy-amine adduct applied in the pigment pastes), a blocked isocyanate as crosslinking component (c) and also further constituents like, in particular, customary additives, organic co-solvents and water. The constituents of the binder dispersion were added in an individual order, whereby different mixing (dissolving) steps and two dispersing stages took place. The solids contents of the binder dispersion is 36% (binder dispersions B1).

Furthermore, binder dispersions B2 to B4 comprising an alkoxylated polyethyleneimine were produced. The preparation, in principle, was conducted as for dispersion B1. Deviations and differences are as follows:

Binder dispersion B2: After preparation of binder dispersion B1, Sokalan® HP20 (Fa. BASF) was added under stirring.

Binder dispersion B3: During production of binder dispersion B1, the last component added before the first dispersing stage is a crosslinking component (c). Within preparation of binder dispersion B3, directly after addition of crosslinking agent (c) and before starting the first dispersing stage, Sokalan® HP20 (Fa. BASF) was added.

Binder dispersion B4: Preparation of binder dispersion B1 includes a second dispersing stage, whereby the dispersing speed of this step is higher than during the first dispersing stage. Within preparation of binder dispersion B4, Sokalan® HP20 (Fa. BASF) was added directly before the second dispersing stage.

The effective amount of component (b) in the binder dispersions B2-B4 is 2.0 wt.-%, based on the total weight of the respective binder dispersion.

### 1.3 Electrodeposition Coating Material Compositions

By means of the pigment pastes and binder dispersions above, electrodeposition coating material compositions were prepared. While the comparative system was prepared from pigment paste P1 and binder dispersions B1 not including component (b), i.e. an alkoxylated polyethyleneimine, the inventive compositions either included component (b) in the pigment paste or the binder dispersion.

Details on the respective baths and their constituents are shown in Table 1 The constituents listed in the Table have been mixed with each other in this order, whereby electrodeposition coating material compositions for application (item 2. below) were formed.

TABLE 1
Electrodeposition coating material compositions

| | Comparative | Inventive | Inventive | Inventive | Inventive |
|---|---|---|---|---|---|
| | composition | Comp. 1 | Comp. 1 | Comp. 1 | Comp. 1 |
| | (C) | (E-1) | (E-2) | (E-3) | (E-4) |
| Deionized | 2688 | 2688 | 2648 | 2897 | 2682 |
| water | | | | | |
| Binder | 2170 | 2170 | | | |
| dispersion B1 | | | | | |
| Binder | | | 2212 | | |
| dispersion B2 | | | | | |
| Binder | | | | 1951 | |
| dispersion B3 | | | | | |
| Binder | | | | | 2176 |
| dispersion B4 | | | | | |
| Pigment Paste | 550 | | 550 | 550 | 550 |
| P1 | | | | | |
| Pigment Paste | | 550 | | | |
| P2 | | | | | |
| Further additive | 92 | 92 | 90 | 102 | 92 |
| (e)) | | | | | |
| Sum | 5500 | 5500 | 5500 | 5500 | 5500 |
| pH of | 4.8 | 4.8 | 5.0 | 5.1 | 4.9 |
| composition | | | | | |

As can be observed from the above, the amount of component (b) in inventive composition (E-1) is 2000 ppm, while in inventive compositions (E-2) to (E-4) the amount is approximately 0.95 wt.-% (or 9500 ppm), in each case based on the total weight of the bath.

### 2. Electrodeposition Coating of Substrates

Coating films obtained from the electrodeposition coating material compositions described above under Item 1.3 are deposited on cathodically connected test panels at a deposition voltage of 220 V and a coating bath temperature of 32° C. and baked at a substrate temperature of 175° C. for 15 minutes afterwards, to obtain a coating layer thickness of 20 Micrometer.

As test panels cold-rolled steel substrates which were pretreated with a phosphatizing composition (spray applied zinc manganese phosphatizing composition) were used (Gardobond® GB26S 6800 OC)). Before pretreatment, the test panels were punched to result in seven individual holes. These holes and its edges, respectively, were not sanded or polished, meaning that they resemble respective non-sanded/polished edges of real-life substrates.

Table 2 shows details on the prepared cured coatings on substrates which were investigated according to item 3. below.

TABLE 2
Cured coatings on substrates

| | Electrodeposition |
|---|---|
| Cured coating on | coating material |
| substrate | composition |
| S-C | C |
| S-E-1 | E-1 |
| S-E-2 | E-2 |
| S-E-3 | E-3 |
| S-E-4 | E-4 |

### 3. Investigation of the Properties of the Coated Substrates

According to the above-described methods, the corrosion resistance of the cured coatings on substrates were investigated. More specifically, the coatings on substrates were investigated in terms of several or all of the following properties:
Edges of holes corrosion (edge corrosion), Salt Spray Test 1008 hours (SST 1008)
Edge corrosion, VDA climate change test 10 Cycles (VDA 10)
Scribe corrosion, SST 1008
Surface Roughness

Tables 4 shows the respective data regarding corrosion testing

| | SST 1008 | SST 1008 | VDA 10 |
|---|---|---|---|
| | Edge | Scribe | Edge |
| | corrosion | corrosion | corrosion |
| S-C | 0.7 | 0.2 | 2.7 |
| S-E-1 | 0.0 | 0.2 | 0.3 |
| S-E-2 | 0.7 | 0.4 | 1.0 |
| S-E-3 | 0.3 | 0.3 | 0.3 |
| S-E-4 | 0.0 | 0.2 | 0.0 |

The results show that the inventive compositions and cured coatings, respectively, show significantly enhanced edge corrosion protection. Similarly, the influence on scribe corrosion is neglectable or at least not very high.

Furthermore, the results on surface roughness for all investigated systems lies in a principally acceptable range of between 0.5 and 1.0, meaning that no relevant negative impact on surface roughness was observable.

1. An aqueous cathodically depositable electrodeposition coating material composition comprising
(I) at least one binder dispersion comprising at least one cathodically depositable polymer (a) and
(II) at least one pigment paste comprising at least one pigment and/or filler,
wherein manufacture of the electrodeposition coating material composition comprises mixing the binder dispersion (I) and the pigment paste (II), and
wherein the composition also comprises at least one alkoxylated polyethyleneimine (b) and
wherein the at least one alkoxylated polyethyleneimine (b) is part of the at least one binder dispersion (I) and/or part of the at least one pigment paste (II).

2. The coating material composition according to claim 1, wherein the polyethyleneimine moiety of the at least one alkoxylated polyethyleneimine (b) is a branched polyethyleneimine moiety.

3. The coating material composition according to claim 1, wherein the at least one alkoxylated polyethyleneimine (b) is selected from the group consisting of an ethoxylated polyethyleneimine, a propoxylated polyethyleneimine, a mixed ethoxylated/propoxylated polyethyleneimine, and combinations thereof.

4. The coating material composition according to claim 3, wherein the at least one alkoxylated polyethyleneimine (b) is an ethoxylated polyethyleneimine.

5. The coating material composition according to claim 1, wherein the at least one alkoxylated polyethyleneimine (b) has a degree of alkoxylation, defined as the average number of polymerized alkoxy moieties, defined as O-alkyl-moieties, per alkoxylation modification on amino groups, in a range of from 10 to 100.

6. The coating material composition according to claim 1, wherein the at least one alkoxylated polyethyleneimine (b) has a number average molecular weight of from 2500 to 30000 g/mol.

7. The coating material composition according to claim 1, wherein the amount of component (b) included in the composition is in a range of from 0.01 to 10 wt.-%, based on the total weight of the electrodeposition material coating composition.

8. The coating material composition according to claim 1, wherein at least one epoxide-amine adduct is present as at least one polymer (a).

9. The coating material composition according to claim 1, wherein the at least one epoxide-amine adduct is present as at least one polymer (a), which is a reaction product of at least one epoxy resin based on bisphenol A and at least one primary and/or secondary amine and/or salts thereof and/or at least one tertiary amine or salt thereof.

10. The coating material composition according to claim 1, wherein it contains at least one crosslinking agent component (c).

11. The coating material composition according to claim 10, wherein at least one blocked polyisocyanate is present as at least one crosslinking agent component (c).

12. A kit of parts for manufacturing an aqueous cathodically depositable electrodeposition coating material composition, comprising
(I) at least one binder dispersion comprising at least one cathodically depositable polymer (a), and
(II) at least one pigment paste comprising at least one pigment and/or filler,
wherein at least one alkoxylated polyethyleneimine (b) is part of the at least one binder dispersion (I) and/or part of the at least one pigment paste (II).

13. A method of manufacturing a cathodically depositable electrodeposition coating material composition comprising
providing at least one binder dispersion (I) comprising at least one cathodically depositable polymer (a),
providing at least one pigment paste (II) comprising at least one pigment and/or filler,
wherein the binder dispersion (I) and/or the pigment paste (II) comprises at least one alkoxylated polyethyleneimine (b), and
mixing the binder dispersion (I), the pigment paste (II) and any further potential components of the composition.

14. A method for at least partially coating an electrically conductive substrate by cathodic electrodeposition coating comprising at least steps (1) to (5),
(1) immersing the electrically conductive substrate at least partially into an electrodeposition coating bath, which comprises the electrodeposition coating material composition according to claim 1,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

15. The method according to claim 13, wherein it comprises at least one further step (6),
(6) applying at least one further coating material composition, which is different from the composition applied in step (1), at least partially onto the baked coating film obtained after step (5).

16. An electrically conductive substrate which is at least partially coated with an electrodeposition coating material composition as claimed in claim 1.

17. A method of using at least one alkoxylated polyethyleneimine of claim 1, the method comprising using the at least one alkoxylated polyethyleneimine for improving the edge corrosion protection of electrically conductive substrates bearing a baked coating film obtained from an aqueous cathodically depositable electrodeposition coating material compositions comprising, besides the at least one alkoxylated polyethyleneimine(b), at least one cathodically depositable polymer (a).

18. An electrically conductive substrate which is at least partially coated with an electrodeposition coating material composition manufactured according to claim 12 in a baked form.

19. An electrically conductive substrate which is at least partially coated with an electrodeposition coating material composition which is obtained by the method of claim 13.

20. An electrically conductive substrate which is at least partially coated with an electrodeposition coating material composition which is obtained by the method of claim 14.
